(19) United States
(12) Patent Application Publication
(10) Pub. No.: US 2005/0161962 A1
(43) Pub. Date: Jul. 28, 2005

(54) Portable lifting device

(76) Inventor: John Topper, Fremont, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/763,531

(22) Filed: Jan. 23, 2004

(51) Int. Cl. B66C 1/10

(52) U.S. Cl. 294/1.1

(57) ABSTRACT

The present invention includes a portable lifting device for use on a temporary basis to lift objects up to, or to lower down from, an elevated height, particularly a roof of a multi-story building. The portable lifting device includes a catch, a bob, a securing means for attaching the catch to a load and a tether. The catch includes a top panel having at least on elongated slot an entry hole. The bob has a weighted body, a shank, and a tether anchor connected to the shank. The bob enters the catch through the entry hole wherein one the elongated slot receives the shank. When vertical tension is applied to the tether, the weighted body contacts the bottom surface of the top panel allowing the user to raise or lower the catch and attached load.

### FIELD OF INVENTION

The present invention pertains to the movement of cargo, and more specifically to portable lifting devices for use on a temporary basis to lift objects up to, or to lower down from, an elevated height, particularly a roof of a multi-story building.

### BACKGROUND OF INVENTION

There are many instances in which a load must be raised to or lowered from an elevated level, such as the roof of a building. For instance, air conditioner service men often carry air filters to the roof of a building using an internal stairwell. The air filters are often bulky and difficult to carry in a stairwell. Similarly, the used filters must be carried to the ground for disposal. When an air conditioner service man goes to a job site to replace air filters, he often goes alone. Having an assistant to carry the filters can be a wasteful use of the assistant's time and costly to the customer. Depending on the size and quantities of the air filters, it may take the service man several trips to bring all the filters to the roof causing delays in servicing the air conditioner unit.

In addition, small multi-story buildings oftentimes do not have elevators, or interior stairwells for transporting goods and other cargo. In such cases, cargo access may be provided by exterior stairs, landings, balconies or vertical mounted ladders. These types of units may require a person to carry large cumbersome items up a large number of steeply inclined steps. Typical goods and supplies carried in these situations, while oftentimes bulky and numerous, are usually lightweight.

Many lifting devices have been created in an effort to assist service men and construction workers raise loads to and lower cargo from an elevated position. Many pre-existing lifting devices attach to ladders and include the use of mechanical winches to raise and lower the loads, and many also include a number of moving parts, which may increase cost and reduce reliability. The major deficiency with these pre-existing ladder attachments is there limited functionality. These types of devices only work at the periphery of a building, where the foot of a ladder is resting on the ground, spaced from but fairly close to the edge of a building. These types of devices are not designed for use between the middle stories of a multi-storied building. Furthermore, these types of devices are limited to the working length of the ladder.

Other pre-existing lifting devices include scaffolding, cranes and hoists. These types of lifting devices are typically designed for long-term use involving heavy loads or multiple users, such as found on construction sites. These types of lifting devices are typically secured to the exterior surface of the building and are not practical for temporary use. In addition, these types of devices require multiple personnel to assemble and disassemble and are not easily transported to various job sites.

What is needed is a portable lifting device may avoid disadvantages of pre-existing devices, that can be used on a temporary basis to lift objects up or to lower objects down from an elevated height, that can be operated by one person, that can be used on buildings with multiple stories, and that can be easily transported to various job sites.

### SUMMARY OF INVENTION

Accordingly, the present invention is a portable lifting device for use on a temporary basis to lift objects up to, or to lower down from, an elevated height, particularly a roof of a multi-story building. The present invention is particularly suited for use on small multi-storied building requiring the need to raise or lower bulky cumbersome, but lightweight cargo between the ground and the roof of a two or three story building. However, the portable lifting device of the present invention is not limited to bulky, cumbersome, lightweight cargo and may be used with other kinds of cargo, with buildings of different heights or raising and lowering cargo between floors of a multi-storied building.

A portable lifting device built in accord with the invention may include a catch, a securing means for attaching the catch to a load, a bob to engage the catch, and a tether such as a rope, cable, chain or the like. Alternatively, the catch may be formed directly on an object to be lifted, for example, on the lid of a bucket or tool box.

In some embodiments catch is constructed from a single piece of durable rigid material. In some embodiments the catch further includes features to provide a space under the catch to allow the bob to pass through an aperture in the catch. For example, in one embodiments four side panels and a top panel are provided. However, in alternate embodiments it may be possible to use three side panels or more than four side panels or include a bottom panel. The side panels may be permanent or removable.

In one embodiment each side panel is identical in size and shape, which may provide manufacturing and stocking benefits. In such embodiment, each side panel may be then bent vertically downward at approximately a right angle to the top panel so that the perimeter of the four side panels forms a geometric square. In alternate embodiments the geometric shape formed by the outer perimeter of the side panels may form a rectangle or other geometric shape depending on the size and shape of the side panels and top panels used. In prototype construction, the catch was made of 0.0625 inch steel; however, many other kinds of material may be acceptable.

In another embodiment, the four side panels slope outwardly downward, so that the area defined by an opening at the bottom of the catch is larger than the top panel. The first side edge of each panel is shaped to be adjacent to the second side edge of a second side panel when the side panels are bent vertically downward during the manufacturing process. The bottom edge of each side panel may be used to contact the cargo to be lifted.

In further embodiments, the top panel has four elongated slots uniformly spaced within the top panel, wherein each elongated slot is defined by a receiving end and a confining end. Each elongated slot may be uniform in length and width. In one preferred embodiment, each of the confining ends is directed toward one of the corners of the top panel, forming an “X” shape. In alternate embodiments, the elongated slots may be any geometric shape, so long as each entry portion is adjacent to one another. It is generally preferable that the intersection of the receiving end of each elongated slot form an entry hole near the geometric center of the top panel. In alternate embodiments, the entry hole may not be located at the geometric center of the top panel depending on the length and width of each elongated slot. In alternate embodiments it may be possible to use as few as one elongated slot or more than four elongated slots.

In other embodiments, the top panel includes a concave depression with the entry hole positioned at the bottom of the depression. The concave depression may help guide the bob toward the entry hole. The concave depression also necessitates physical removal of the bob from the elongated slot by the user to prevent inadvertent removal of the bob from the catch while the portable lifting device is used to raise and lower the load.

In some embodiments, the bob has a cylindrical body with a cylindrical shank extending centrally from one end; the shank being suitably sized to be received by the elongated slot. The body and shank should be constructed of material selected to have sufficient shear and tensile strength for this purpose, and should be sufficiently heavy to freely fall through the entry hole. The diameter of the cylindrical body is larger than the diameter of the shank, which defines an annular engaging shoulder about the shank. The annular engaging shoulder prevents passage of the cylindrical body through the elongated slot.

In further embodiments, a tether anchor is affixed to the shank opposite the cylindrical body. The tether anchor may be suitably sized to prevent passage through the entry hole, which construction allows only passage of the cylindrical body and shank through the entry hole, thus ensuring the annular engaging shoulder engages the bottom surface of the top panel. A tether, which may comprise any acceptable material including known ropes, chains, cables, and the like, is removably coupled to the tether anchor at one end. The opposite end of the tether is held by the user or by a mechanical device to apply the requisite vertical force to move the catch in a vertical direction. The vertical force may be applied by human, or mechanical means such as a manual or electric winch.

In other embodiments, a securing means attaches the catch to the load to be moved. In some embodiments, the securing means is a pair of nylon straps; each nylon strap having a buckle on one end. In this embodiment, each side panel has an opening at the bottom edge, which allows the securing means to pass freely through the side panel. In alternate embodiments, the catch may be formed directly on a surface of the object to be lifted.

Upon manual positioning of the bob through the entry hole, the concave depression of the top surface assists the user in guiding the bob in an outwardly direction away from the entry hole as the bob travels the length of the elongated slot. The annular engaging shoulder contacts the bottom surface of the top panel. Once the bob is properly situated in the confining end of a slot, an object or objects to which the catch is attached may be lifted or lowered.

Another aspect of the invention is that the invention may be used by a single person by attaching catches to several loads. The user simply pulls each load up, detaches the bob, and lowers the bob for the next load. A single user can also use the apparatus of the invention to lower loads. This may be done with the load on the ground and a single user on a roof, so that the user can pull the tether back up to lower another load. For example, a user positioned on a roof can lower the object until the load or object has reached the ground. The user allows slack in the tether when the load is on the, such that the bob moves down the slot toward the entry hole. The bob can then be pulled out through the entry hole.

### BRIEF DESCRIPTION OF THE DRAWINGS

A preferred embodiment of the present invention is further described in connection with the accompanying drawings, in which:

FIG. 1 is a perspective view of a preferred embodiment of the portable lifting device according to the present invention.

FIG. 2 shows a top view of an embodiment of the catch of the portable lifting device according to the present invention.

FIG. 3 shows a cross-sectional side view of an embodiment of the catch of the portable lifting device according to the present invention.

FIG. 4 shows an embodiment of the invention wherein the catch is formed in the lid of a tool box.

FIG. 5 shows an embodiment of the invention wherein the catch is formed in the lid of a bucket.

### DETAILED DESCRIPTION OF THE INVENTION

The following description is provide to enable any person skilled in the art to make and use the invention and sets forth the best mode presently contemplated by the inventor for carrying out his invention. Various modifications, however, will remain readily apparent to those skilled in the art, as generic principles of the present invention have been defined herein.

The present invention is a portable lifting device for use on a temporary basis to lift objects up to, or to lower down from, an elevated height, particularly a roof of a multi-story building. The portable lifting device of the present invention is particularly suited for use on small multi-storied building requiring the need to raise or lower bulky cumbersome, but lightweight cargo. The embodiments described herein are configured for raising and lowering bulky, cumbersome, lightweight cargo between the ground and the roof of a two or three story building. However, the portable lifting device of the present invention is not limited to bulky, cumbersome, lightweight cargo and may be used with other kinds of cargo, with buildings of different heights or raising and lowering cargo between floors of a multi-storied building.

A portable lifting device built in accord with the invention may include a catch, a securing means for attaching the catch to a load, a bob to engage the catch, and a tether, which may include a rope, cable, chain, or the like. Alternatively, the catch can be formed directly on an object to be lifted, such as the lid of a bucket or tool box.

Reference will now be made in detail to a presently preferred example embodiment of the invention as illustrated in the accompanying drawings.

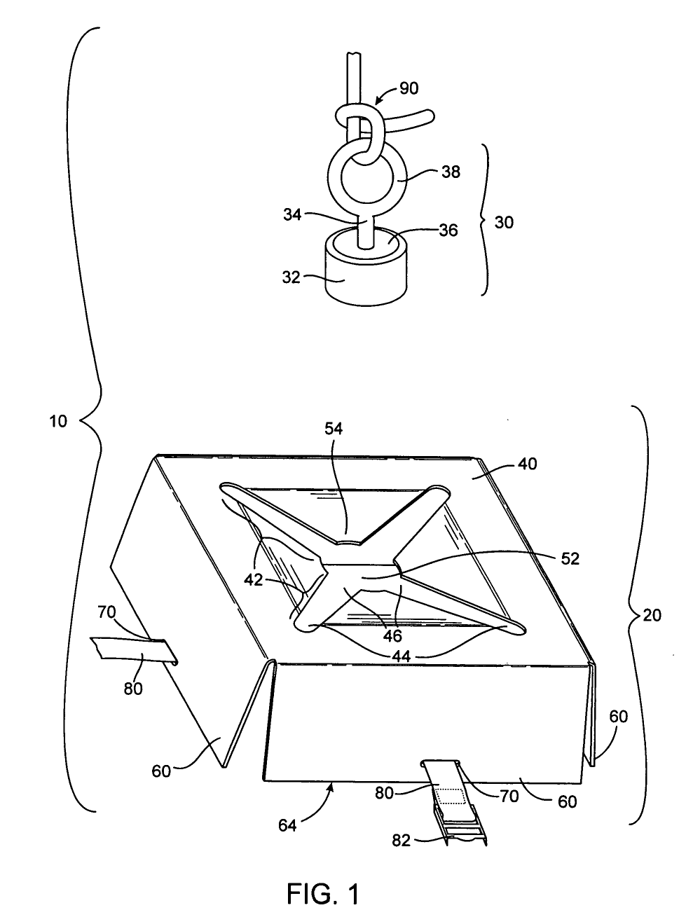

In an example embodiment, seen in FIGS. 1, 2 and 3, the portable lift device 10 comprises a catch 20, a bob 30, a securing means 80 for attaching the catch to a load, and a tether 90. The catch 20 is preferably constructed from a single piece of durable rigid material and comprises four side panels 60 and a top panel 40. However, in alternate embodiments it may be possible to use fewer side panels or more than four side panels or include a bottom panel with minor modifications easily made by one skilled in the art. In the preferred embodiment, the top panel 40 preferably has four elongated slots 42. In alternate embodiments it may be possible to as few as one elongated slot or more than four elongated slots with minor modifications, made easily by one skilled in the art, to the top panel. Each elongated slot 42 is defined by a confining end 44 and an opposing receiving end 46. The receiving end 46 of each slot joins an entry hole 52 near the geometric center of the top panel 40. The top panel 40 preferably has a concave depression towards the geometric center between each elongated slot 42. In prototype construction, each elongated slot is uniform in length and width. In alternate embodiment, the elongated slots may vary in length and width.

In the example embodiment seen in FIG. 1, the bob 30 has a cylindrical body 32 with a shank 34 extending centrally from one end. The extension of the shank 34 away from the cylindrical body 32 forms an annular engaging shoulder 36 about the shank 34. A tether anchor 38 is connected to the shank 34 opposite the cylindrical body 32. In alternate embodiments, the bob 30 may be any acceptable shape, including but not limited to a sphere or a cube, so long as a shoulder or other surface is provided to contact the bottom surface 48 of the top panel 40 of the catch 20. The bob 30 enters the catch 20 through the entry hole 52. The elongated slot 42 receives the shank 34 and allows manual slidable positioning of the bob 30 into the confining end 44. When vertical tension is applied to the tether 90, the annular engaging shoulder 36 contacts the bottom surface 48 of the top panel 40 allowing the user to raise or lower the catch 20.

In some embodiments, the catch 20 is constructed from a single piece of durable rigid material, with the top panel 40 and four side panels 60 cut from a single flat piece. In the embodiments seen in FIGS. 1-3 of each side panel 60 is identical in size and shape, each side panel 60 is bent vertically downward at approximately a right angle to the top panel 40, which may provide manufacturing and stocking benefits, such as allowing the catches to be stacked. However, in alternate embodiments the side panels may be configured differently as desired. In alternate embodiments the geometric shape formed by the outer perimeter of the catch 20 may form other desired geometric shapes. In prototype construction, the catch was made of 0.0625 inch steel; however, many other kinds of material may be acceptable.

In the preferred embodiment, each side panel 60 is has a bottom edge 64, a first side edge 66 and a second side edge 68. The first side edge 66 of each panel is shaped to be adjacent to the second side edge 68 of a second side panel when the side panels are bent vertically downward during the manufacturing process. The bottom edge 64 of each side panel may contact the cargo to be lifted, and holds the top panel 40 above the surface of the cargo so that the bob 30 has sufficient room to pass through the entry hole 52.

In alternate embodiments, the catch 20 may include separate side panels and a top panel. In these alternate embodiments, the first side edge of each side panel is shaped to receive the second side edge of a second side panel. It may be preferable that the side panels are secured together with a removable securing means. In these alternate embodiments, the top edge of each side panel is shaped to receive the outer perimeter of the top panel. The top panel is preferably secured to each side panel with a removable securing means. Any removable securing mechanism capable of securing the side panel to each other and to the top panel may be used.

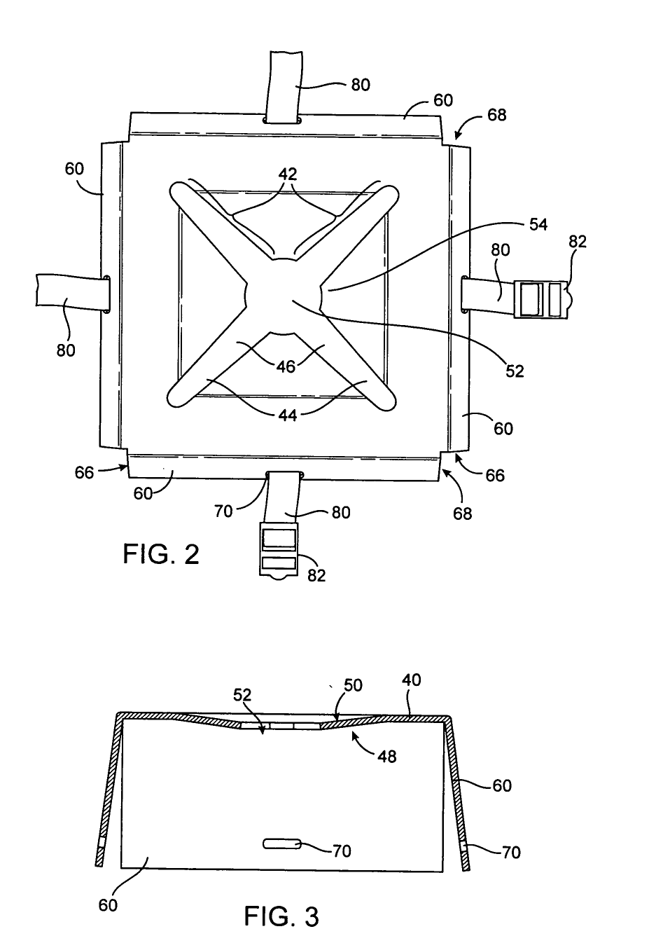

Referring to FIG. 2, the elongated slots 42 are uniformly spaced within the top panel 40 with the receiving end 46 of each elongated slot adjacent to one another. Each of the confining ends 44 is directed toward one of the corners of the top panel 40, forming an “X” shape. The concave depression causes the receiving end 46 of each elongated slot 42 to widen thus giving the elongated slot 42 a tapered shape. In alternate embodiments, the elongated slots may be any practical geometric shape. It is preferable that the intersection of the receiving end 46 of each elongated slot join an entry hole 52 near the geometric center of the top panel 40. In alternate embodiments, the entry hole may not be located at the geometric center of the top panel depending on the length and width of each elongated slot. Furthermore, in alternate embodiments, there may be more than one entry hole with one or more associated slots.

Referring to FIG. 3, the top panel 40 may include a concave depression towards the entry hole 52. The concave depression helps the user guide the bob 30 toward the entry hole 52. The concave depression may help prevent inadvertent removal of the bob 30 from the catch 20 while the portable lifting device 10 is used to raise and lower the load.

Referring to FIG. 1, the bob 30 has a cylindrical body 32 with a shank 34 extending centrally from one end. The extension of the shank 34 away from the cylindrical body 32 forms an annular engaging shoulder 36 about the shank 34. A tether anchor 38 is connected to the shank 34 opposite the cylindrical body 32. The body 32 is sized to fit into the entry hole 52 through the top surface 50 of the top panel 40, but not through the elongated slot 42. It is preferable that the cylindrical body 32 be of sufficient weight to freely fall through the entry hole 52. In prototype construction, the body was made of steel; however, any suitable material with sufficient weight and shear and tensile strength may be used. In alternate embodiments, the body may be any geometric shape of sufficient size to fit through the entry hole.

The shank 34 is cylindrical in shape and suitably sized to be received by the elongated slot 42. However, any geometric shape of suitable size may be used for the shank. In the preferred embodiment, the shank 34 and cylindrical body 32 are constructed from a single piece of material. In alternate embodiments, the shank and cylindrical body may be separate components which are physically connected to one another.

The tether anchor 38 is a ring affixed to the shank 34. In alternate embodiments, the tether anchor may comprise a hook, notch or other feature capable of accepting the tether 90. In further embodiments, the tether anchor 38 may swivel about the shank 34. The tether anchor 38 is suitably sized to prevent passage through the entry hole 52. This construction allows only passage of the cylindrical body 32 and shank 34 through the entry hole 52, thus ensuring the annular engaging shoulder 36 engages the bottom surface 48 of the top panel 40.

The extension of the shank 34 away from the cylindrical body 32 forms an annular engaging shoulder 36 about the shank 34. The annular engaging shoulder 36 prevents passage of the cylindrical body 32 through the elongated slot 42. Upon manual positioning of the bob 30 through the entry hole 52, the concave depression of the top surface 50 assists the user in guiding the bob 30 in an outwardly direction away from the entry hole 52 as the bob 30 travels the length of the elongated slot 42. Once the bob 30 is properly situated in the confining end 44, application of a vertical force to the bob 30 is applied. The annular engaging shoulder 36 contacts the bottom surface 48 of the top panel 40. When sufficient vertical force is applied to the bob 30, the catch 20 will be moved in a vertical direction.

A tether 90 is removably coupled to the tether anchor 48 at one end. The opposite end of the tether 90 is held by the user or mechanical device to apply the requisite vertical force to move the catch 20 in a vertical direction. In prototype construction, the tether was a rope of sufficient length. However, any type of tether may be used, such as nylon strapping, steel chain and steel cable. The vertical force may be applied by human or mechanical means, such as a manual or electric winch.

A securing means 80 is used for attaching the catch 20 to the load to be moved. In the preferred embodiment, the securing means 80 is a pair of nylon straps; each nylon strap having a buckle 82 on one end. However, any means for securing the catch to the load may be used. In the preferred embodiment, each side panel 60 has an opening 70 near the bottom edge 64. The opening 70 allows the securing means 80 to pass freely through the side panel 60. In alternate embodiments, the means for securing the catch to the load ma be firmly affixed to each side panel. In further embodiments, it may be desirable for the side panels to include a notch, hook or other feature to accept a means for securing the catch to the load.

One example of using of the portable lifting device 10 in accordance with the present invention is described below. The following description is for lifting a load from the ground to an elevated level by manual force. The catch 20 is generally fastened to the top of the load by securing means 80. The user proceeds to the elevated level in which the load is to be raised. A tether 90 of sufficient length is coupled to the tether anchor 38 and the bob 30 slowly lowered toward the catch 20. The bob 30 is allowed to contact the top panel 40. The concave depression of the top panel directs the bob toward the entry hole 52. The cylindrical body 32 and shaft 34 are allowed to fall through the entry hole 52. By applying a horizontal force to the tether 90, the user manually positions the shaft 34 into one of the elongated slots 42. The concave depression of the top surface 50 assists the user in guiding the bob 30 in an outwardly direction away from the entry hole 52 as the bob 30 travels the length of the elongated slot 42. Once the bob 30 is properly situated in the confining end 44, application of a vertical force to the tether 90 is applied. The vertical force causes the annular engaging shoulder 36 to contact the bottom surface 48 of the top panel 40. When sufficient vertical force is applied to the bob 30, the catch 20 with its fastened load will be moved in a vertical direction. The user raises the load to the desired height by shortening the length of tether 90 between the user and tether anchor 38. Once the load is at the desired height, the user grabs the load and moves it to the desired location. The user then physically removes the bob 30 from the catch 20 by sliding the bob 30 along the elongated slot 42 toward the entry hole 52. The cylindrical body 32 and shaft 34 are then lifted vertically to remove the bob 30 from the catch 20.

The invention can also be used to lower a load from an elevated height, and moving loads between two elevated positions and lifting multiple loads, will be obvious to one skilled in the art. Another aspect of the invention is the ability of the user to remotely disconnect the bob 30 from the catch 20 when the cargo is on a support surface such as the ground. To do this, the user allows slack in the tether 90 when the cargo is on the ground, such that the bob 30 slides along the slot 42 toward the entry hole 52, where the bob 30 pulled out through the entry hole 52.

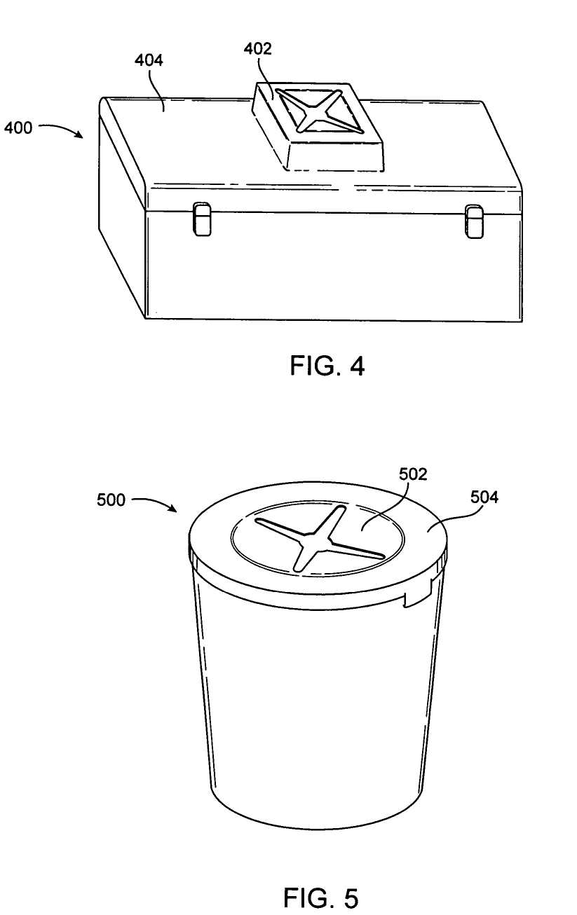

The catch of the portable lifting device of the invention may also be formed directly onto a variety of items or objects, allowing these items to easily be lifted and lowered. Two examples are seen in FIGS. 4 and 5. FIG. 4 shows a catch 402 formed on the top of the lid 404 of a toolbox 400. FIG. 5 shows a catch 502 formed into the lid 504 of a bucket 500. One of ordinary skill in the art could easily modify the invention to be coupled to or formed directly onto a variety of different kinds of items.

The preferred embodiments described herein are illustrative only, and although the examples given include many specifics, they are illustrative of only a few possible embodiments of the invention. Other embodiments and modifications will no doubt occur to those skilled in the art. The examples given should only be interpreted as illustrations of some of the preferred embodiments of the invention, and the full scope of the invention should be determined by reference to the appended claims and their legal equivalents.

1. A portable lifting device comprising:
a catch including a top panel, said top panel having a top surface, a bottom surface and at least one slot, said at lest one slot comprising a confining end and a receiving end open to an entry hole in said top panel,
a bob including weighted body, a shank projecting from said weighted body, and a tether anchor connected to said shank, said weighted body being insertable through said entry hole in said top panel, but not through said at least one slot, said at least one slot being sized to receive said shank, and
a tether attached to said tether anchor.

2. The portable lifting device of claim 1 further comprising a securing means for attaching said catch to said load to be moved.

3. The portable lifting device of claim 1 wherein said entry hole in said top panel is positioned within a concave depression in said top panel.

4. The portable lifting device of claim 1 wherein said shank may be received in said slot, and said weighted body may contact said bottom surface of said top panel when said portable lifting device is used to lift an object.

5. The portable lifting device of claim 1, wherein said catch comprises at least one side panel.

6. The portable lifting device of claim 1, wherein said catch comprises at least four side panels.

7. The portable lifting device of claim 1, wherein said catch comprises a single piece of durable rigid material.

8. The portable lifting device of claim 1, wherein said catch comprises bottom panel.

9. The portable lifting device of claim 1, further comprising a means for securing said catch to an object to be lifted.

10. The portable lifting device of claim 1, wherein said securing means comprises at least one strap.

11. The portable lifting device of claim 1, wherein said at least one slot comprises four slots.

12. The portable lifting device of claim 1, wherein the weighted body comprises a durable rigid material.

13. The portable lifting device of claim 1, wherein said weighted body is cylindrical in shape.

14. The portable lifting device of claim 1, wherein said tether anchor is sized to prevent passage through said entry hole.

15. A method for selectively moving a load between a low position and an elevated position the steps comprising:
a. providing a portable lifting device comprising a catch including a top panel, said top panel having a top surface, a bottom surface and at least one slot, said at lest one slot comprising a confining end and a receiving end open to an entry hole in said top panel, a bob including weighted body, a shank projecting from said weighted body, and a tether anchor connected to said shank, said weighted body being insertable through said entry hole in said top panel, but not through said at least one slot, said at least one slot being sized to receive said shank, a tether attached to said tether anchor;
c. securing said catch to said load;
d. lowing said bob to said catch and allowing said weighted body of said bob to pass through said entry hole;
e. moving said shaft into one said slot;
f. applying a vertical force to said tether causing said weighted body to contact said the bottom surface of said top panel; and
g. adjusting a length of tether between a user and said tether anchor to raise or lower said load.

16. The method of claim 15 further comprising the steps:
h. lowering said load to a support surface;
i. allowing said shaft to move in said slot toward said entry hole; and
j. pulling said weighted body upward through said entry hole.
